(19) United States
(12) Patent Application Publication
(10) Pub. No.: US 2009/0066568 A1
(43) Pub. Date: Mar. 12, 2009

(54) MONITORING SYSTEM

(76) Inventors: Stephan Britz, Stellenbosch (ZA); Nico Bestbier, Brackenfell (ZA)

Correspondence Address: STITES & HARBISON PLLC, 1199 NORTH FAIRFAX STREET, SUITE 900, ALEXANDRIA, VA, 22314, US

(21) Appl. No.: 11/815,612

(22) PCT Filed: Feb. 9, 2006
(86) PCT No.: PCT/IB2006/050432

§ 371 Date: Oct. 16, 2008

(30) Foreign Application Priority Data
Feb. 10, 2005 (ZA) 2005/01199

(51) Int. Cl. G01S 5/02

(52) U.S. Cl. 342/357.07

(57) ABSTRACT

The invention discloses a monitoring system, which includes at least one tag adapted to be associated with an object to be monitored; at least one field station adapted to determine the relative position of the tag(s) relative to the field station(s); and calculation means for calculating the global positioning system coordinates of the object to be monitored when provided with a tag. The system includes at least one base station adapted to communicate with the field station(s) and/or the tag(s). The system includes triangulation mapping means and pre-plotted GPS (Global Positioning System) mapping means to determine the global positioning system coordinates of the object to be monitored. The system is adapted to be used to determine the global position of movable property and/or equipment at any given time from any given place, and to be used to continuously track and/or monitor objects.

### FIELD OF INVENTION

The present invention relates to a monitoring system.

More particularly, the present invention relates to a monitoring system for monitoring moving objects, such as animals.

### BACKGROUND TO INVENTION

In view of the loss of livestock due to theft or wandering animals, it has become increasingly important for owners to monitor and track livestock and other moving objects. Often the owner has to track or locate a specific animal or item in a vast area to inspect or treat the animal or object.

It is an object of the invention to suggest a monitoring system which will assist in overcoming the afore-mentioned problems.

### SUMMARY OF INVENTION

According to the invention, a monitoring system includes
(a) at least one tag adapted to be associated with an object to be monitored;
(b) at least one field station adapted to determine the relative position of the tag(s) relative to the field station(s); and
(c) calculation means for calculating the global positioning system coordinates of the object to be monitored when provided with a tag.

Also according to the invention, a method for monitoring objects includes the steps of
(a) providing at least one tag associated with an object to be monitored;
(b) providing at least one field station adapted to determine the relative position of the tag(s) relative to the field station(s); and
(c) calculating the global positioning system coordinates of the object to be monitored by means of calculating means.

The system may include at least one base station adapted to communicate with the field station(s) and/or the tag(s).

The system may include triangulation mapping means to determine the global positioning system coordinates of the object to be monitored.

The system may include pre-plotted GPS (Global Positioning System) mapping means to determine the global positioning system coordinates of the object to be monitored.

The system may be used to determine the global position of movable property and/or equipment at any given time from any given place.

The system may be used to monitor and/or control property and/or equipment.

The system may be used to continuously track and/or monitor objects.

The object may be capable of moving.

The system may be used to control equipment.

The tag may be an intelligent, self-contained electronic device.

The tag may be adapted and/or fixed to the object to enable monitoring of vital signs of the object.

The tag may include attaching means to attach the tag to livestock.

The tag may contain a GPS module.

The tag may be adapted to send position information acquired from the GPS module to a field station, adapted to relay the position to the base station.

The base station(s), field station(s) and/or tag(s) is (are) adapted to communicate by means of radio signals, relays information to and from each other and hand-held units.

Field stations may have been surveyed and accorded GPS coordinates.

The calculation means may be adapted to log and evaluate information received from the respective tag(s) and field station(s).

The system may be adapted to provide data to be viewed by approved user(s) globally via the Internet, SMS messaging systems and/or mobile communication devices.

The object may be an animals, live stock, wild life and/or a domestic animal.

The triangulation mapping means may be adapted to measure out/map out of an area in surveying by means of calculations based in a network of triangles measured from a base line.

The system may include GPS mapping means to establish a border and which is adapted to notify the base station if such border is breeched, for example by the tag and/or object.

The system may be adapted to provide the global position of an object at any given time from any given place and monitor some of the vital signs of the object.

The system may be adapted to be utilised for at least of the functions selected from the group comprising
(a) an early warning system against theft;
(b) determining and/or predicting of grazing patterns;
(c) determining the fertility of the animals;
(d) tracking of animal migrations/movements;
(e) facilitating game viewing;
(f) facilitating game hunting; and
(g) determining position of an injured, sick or dead animal.

The system may be adapted to activate/deactivate remote property or equipment.

The system may be adapted to respond on remote system events of remote property or equipment.

The system may be adapted to set and/or obtain remote system properties of remote property or equipment.

The system may be adapted to execute methods on remote systems of remote property or equipment.

The tag may be adapted to communicate via a radio frequency (wireless) link.

The tag may be adapted to transmit and receive data.

The tag may be provided with a unique identification number (UID).

The tag may be unique in order to distinguish it from another tag.

The tag may be adapted to monitor and/or control the object.

The system may be adapted to monitor vitals signs of the animals.

The vital signs may include at least one sign selected from the group comprising heart rate, breathing, temperature body fat and the percentage body fat.

The system may be adapted to provide protection against tampering of the object.

The system may be adapted to monitor any data related to the working of the object.

The system may be adapted to control any function related to the working of the object.

The tag may be self-contained.

The tag may be adapted to be powered by a battery and charged by solar energy and/or electrical energy.

The tag may be adapted to communicate with field stations and/or with another tag.

The field station may be a fixed beacon that gathers information from the individual tags via the wireless link.

The field station may be a mobile hand-held unit.

The field station may be surveyed.

The field station may (in the case of a mobile unit) be provided with a GPS to pin-point its location.

The field station may be adapted to calculate a tag's position, relative to themselves, by means of radio direction finding (RDF) and triangulation.

The tag's absolute position may be a function of the field station's position and the tag's relative position.

The field station(s) may be adapted to communicate position data of the tags to the base station.

The field station may be self-contained.

The field station may be adapted to be powered by a battery and charged by solar energy and/or electrical energy.

The field station may be tamper proof.

The field station may be provided with a unique identification number (UID).

The field station may be unique to distinguished itself from another field station.

The field station may be adapted to communicate (wireless link) with a base station, tags and/or with another field station.

The base station may be adapted to gather the tag and field information.

The information data may be recorded into a database for a user to view at any time.

The system may be adapted to allow a user to view/study the information by way of a graphical user interface (GUI).

The system may be adapted to allow a user to view historical data as well as real time data at the base station or globally via the internet.

The system may be adapted to allow data to be relayed to the user via e-mail or SMS messages.

The system may be adapted to allow a user to query an individual tag for information.

The GUI may be adapted to provide graphical feedback like heart rate over time, temperature over time and position over time.

The GUI may be adapted to be run on a Microsoft or Linux operation system.

The system may be adapted to be operated by a system approved user(s).

The system may include a sensor adapted to send out an electrical pulse adapted to be received by the tag, and which pulse is then analysed to determine the amount of body fat and/or percentage body fat of the object.

The sensor may be located on an ear or other body part of the object.

### BRIEF DESCRIPTION OF DRAWINGS

The invention will now be described by way of example with reference to the accompanying schematic drawings.

In the drawings there is shown in:

FIG. 1: a component layout of a monitoring system in accordance with the invention;

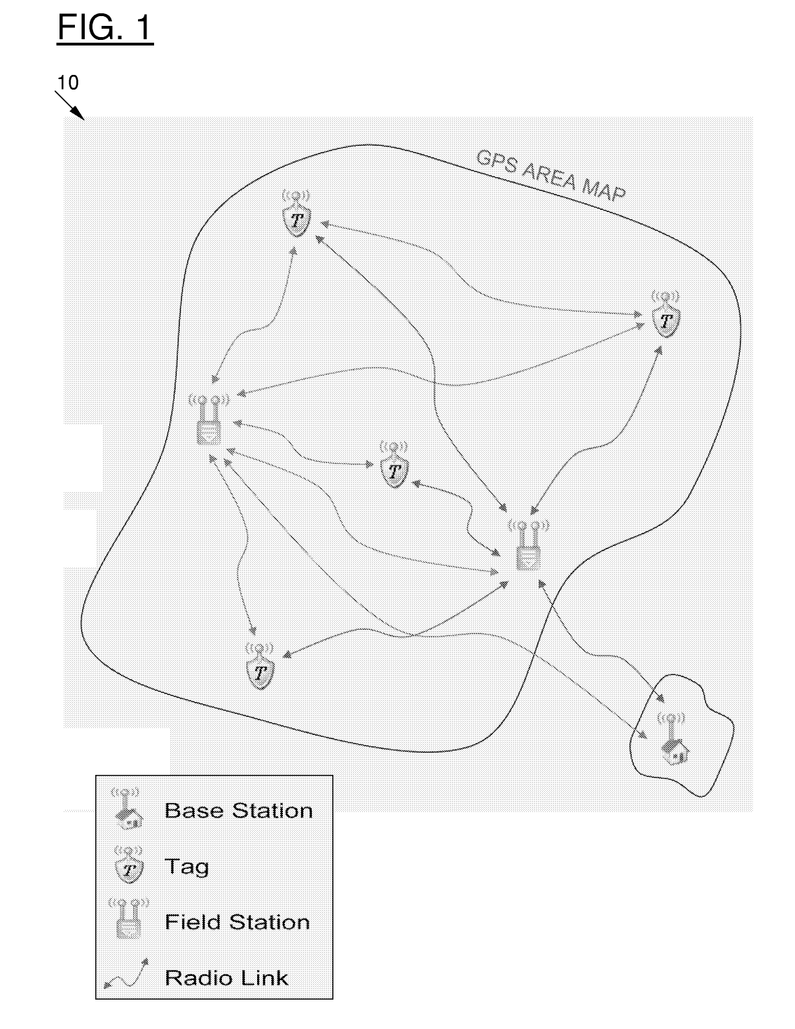

FIG. 2: a component layout of a tag shown in FIG. 1;

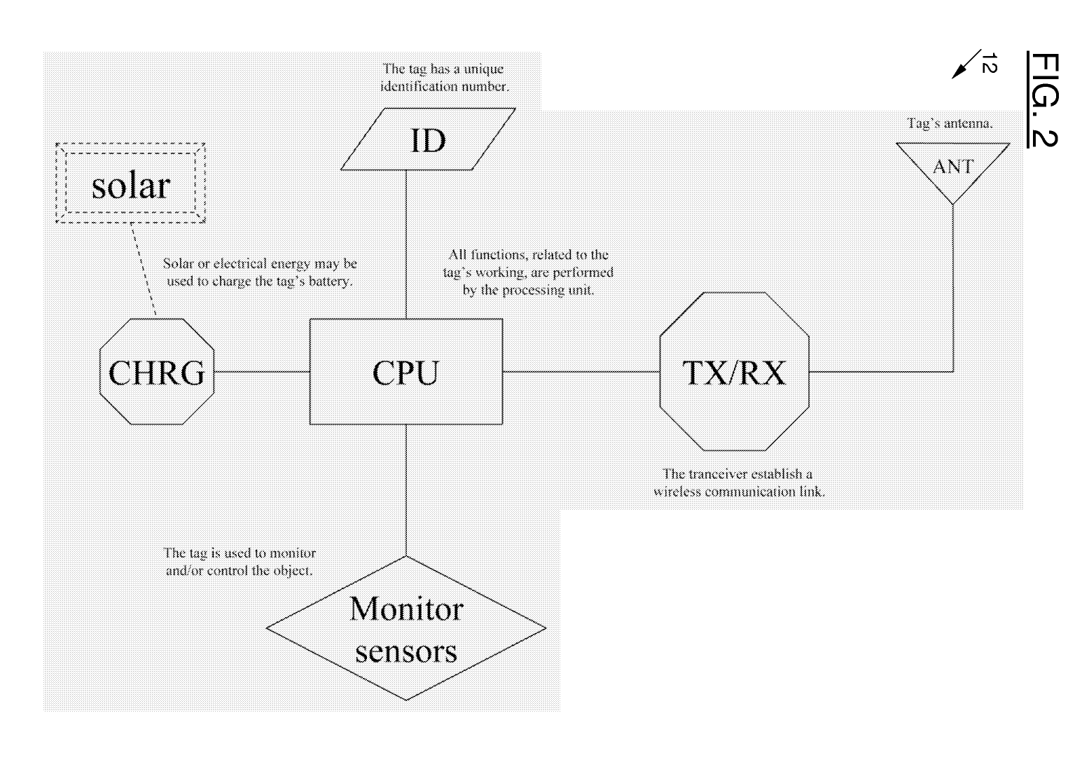

FIG. 3: a component layout of a field station shown in FIG. 1;

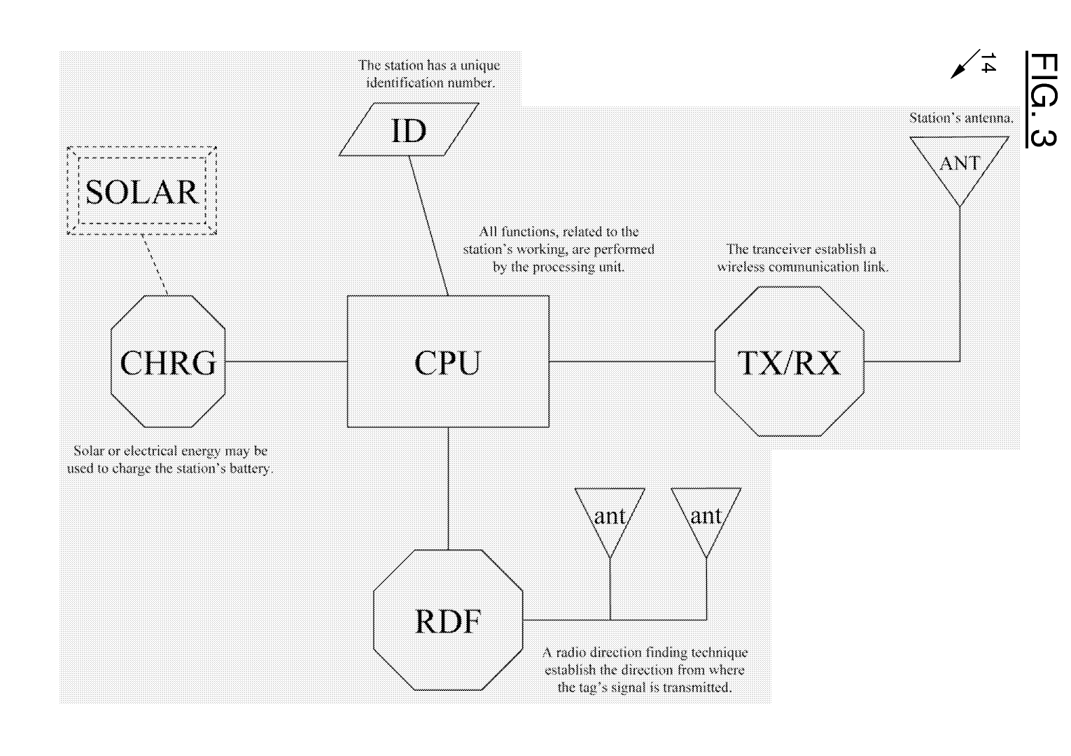

FIG. 4: a component layout of a base station shown in FIG. 1;

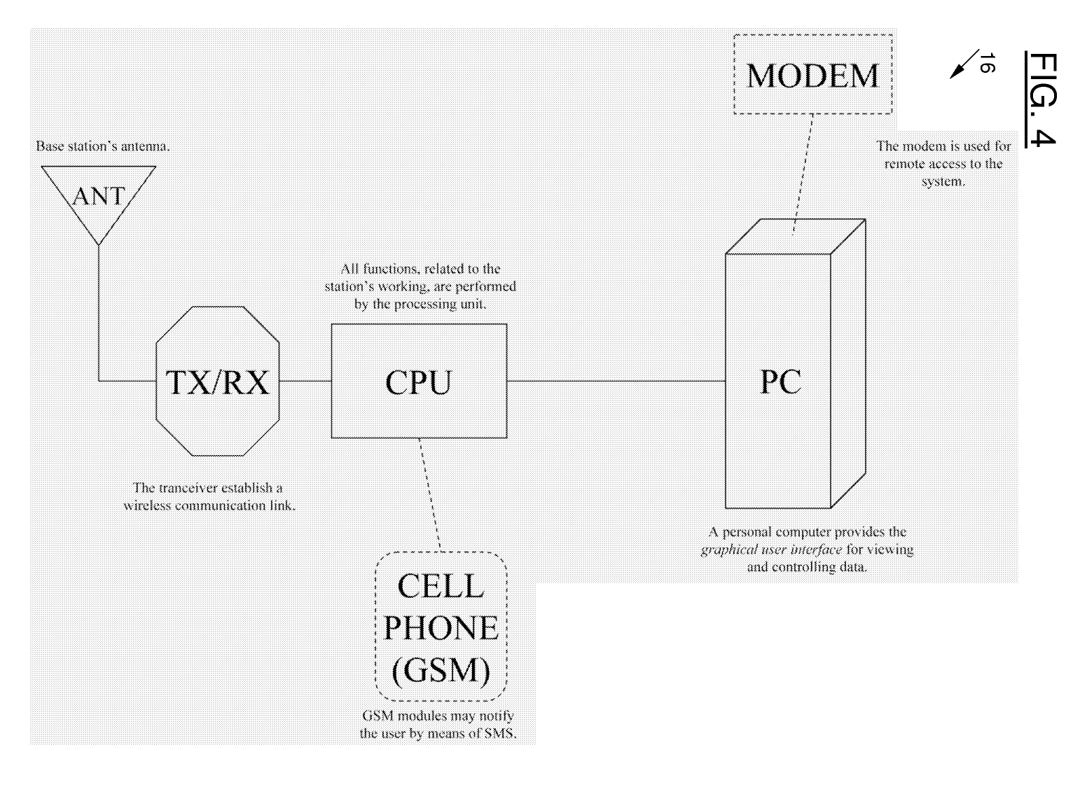

FIG. 5: a circuit layout of the tag according to a first embodiment; and

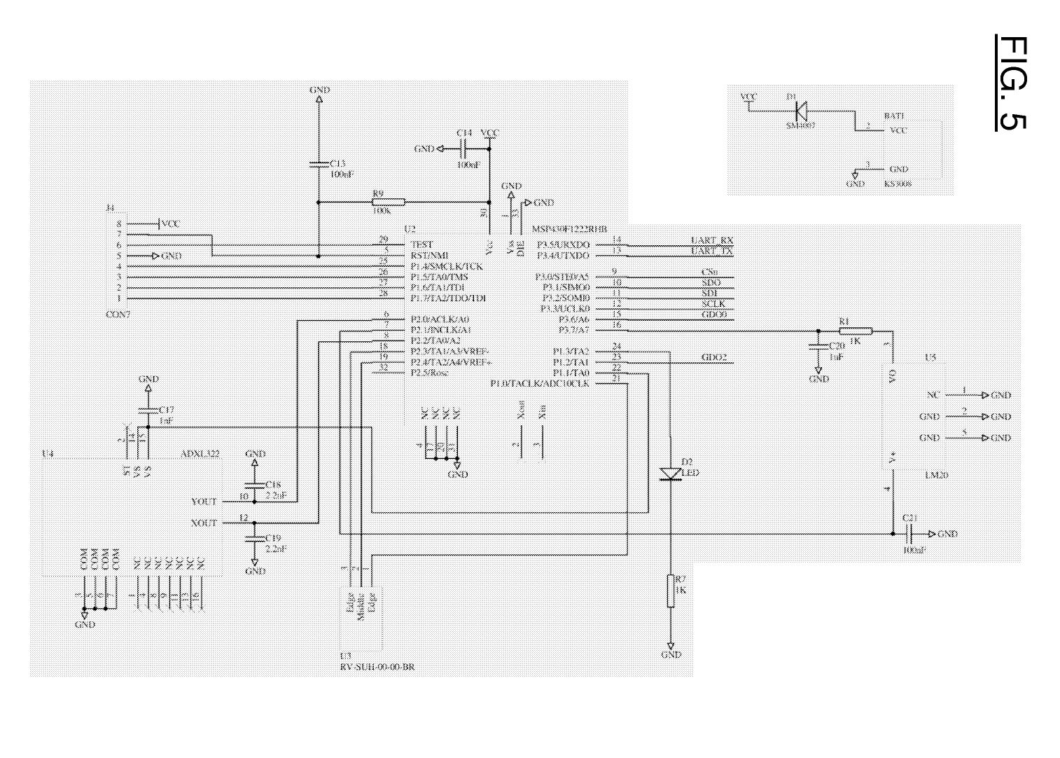

FIG. 6: a circuit layout of the tag according to a second embodiment.

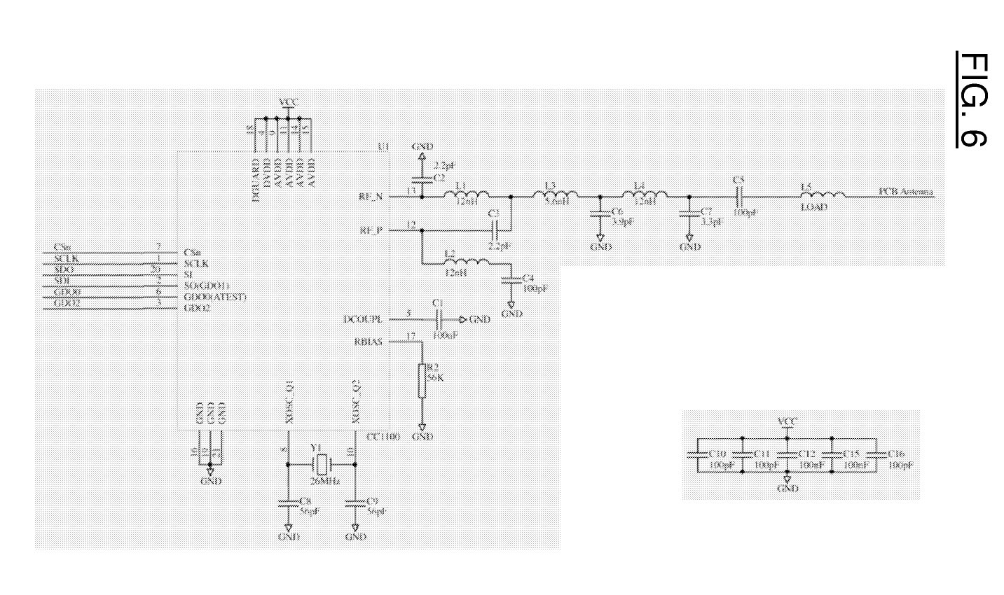

### DETAILED DESCRIPTION OF DRAWINGS

Referring to the drawings, a monitoring system in accordance with the invention, generally indicated by reference numeral 10, is shown.

The monitoring system 10 includes
(a) a tag 12 associated with an object to be monitored;
(b) a field station 14 adapted to determine the relative position of the tag relative to the field station 14;
(c) calculation means located in a base station 16 for calculating the global positioning system coordinates of the object to be monitored.

The base station 16 is adapted to communicate with the field station 14 and the tag 12.

The system 10 employs triangulation mapping means to determine the global positioning system coordinates of the object to be monitored. The system 10 also employs pre-plotted GPS (Global Positioning System) mapping means to determine the global positioning system coordinates of the object to be monitored.

The system 10 can be used
(a) to determine the global position of movable property and equipment at any given time from any given place;
(b) to monitor and control property and equipment; and
(c) to continuously track and monitor objects.

The object can be moving such as an animal and livestock.

The tag 12 is an intelligent, self-contained electronic device and is adapted and fixed to the object to enable monitoring of vital signs of the object.

The base station 16, field station 14 and the tag 12 communicate by means of radio signals, relays information to and from each other and hand-held units.

The field station 14 is surveyed and accorded GPS coordinates.

Information received from the respective tag 12 and field station 14 is logged and evaluated to a user's requirements.

Data of the system can be viewed by approved users globally via the Internet, SMS messaging systems or mobile communication devices.

The object is generally an animal, live stock, wild life or a domestic animal.

Triangulation mapping means measure out/map out of an area in surveying by means of calculations based in a network of triangles measured from a base line.

A border can be established through GPS mapping and means provided which shall notify the base station 16 if such border is breeched.

The system provides the global position of an object at any given time from any given place and monitor some of the vital signs of the object.

The system can thus be utilised for at least one of the functions selected from the group consisting of
(a) an early warning system against theft;
(b) determining and/or predicting of grazing patterns;
(c) determining the fertility of the animals;
(d) tracking of animal migrations/movements;
(e) facilitating game viewing;
(f) facilitating game hunting; and
(g) determining position of an injured, sick or dead animal.

The system 10 is adapted to activate/deactivate remote property or equipment. The system 10 is adapted to respond on remote system events of remote property or equipment. The system 10 is adapted to set and obtain remote system properties of remote property or equipment. The system 10 is adapted to execute methods on remote systems of remote property or equipment.

The tag 12 communicates via a radio frequency (wireless) link. The tag 12 transmits and receive data. The tag 12 is provided with a unique identification number (UID). The tag 12 is unique in order to distinguish if from another tag. The tag 12 monitors and controls the object.

The system 10 monitors vitals signs of the animals such as heart rate, breathing and temperature.

The system 10 provides protection against tampering of the object. The system 10 monitors any data related to the working of the object. The system 10 controls any function related to the working of the object.

The tag 12 is self-contained. The tag 12 is powered by a battery and charged by solar energy or electrical energy. The tag 10 is adapted to communicate with field stations and with another tag.

The field station 14 is a fixed beacon that gathers information from the individual tags 12 via the wireless link. The field station 14 is mobile hand-held unit and can be surveyed, i.e. in the case of a mobile unit be provided with a GPS to pin-point its location.

The field station 14 calculates a tag's 12 position, relative to themselves, by means of radio direction finding (RDF) and triangulation.

The tag's 12 absolute position is a function of the field station's 14 position and the tag's 12 relative position. The position data together with all the tag's data may be transmitted to the base station 16.

The field station 14 is self-contained. The field station 14 is powered by a battery and charged by solar energy or electrical energy. The field station 14 is tamper proof. The field station 14 is provided with a unique identification number (UID). The field station 14 is unique to distinguished itself from another field station. The field station 14 communicates (wireless link) with the base station 16, tags 12 and/or with another field station.

The base station 16 gathers (wireless link) all the tag 12 and field station 14 information. The data is recorded into a database for the user to view at any time. The user views and studies the information through a graphical user interface (GUI). The user can view historical data as well as real time data at the base station 16 or globally via the internet. Data can be relayed to the user via e-mail or SMS messages. The user is able to query an individual tag 12 for information. The GUI provides graphical feedback like heart rate over time, temperature over time and position over time. The GUI can run on a Microsoft or Linux operation system. The system can be operated by a system approved user, thus it will be secure.

The system 10 is adapted to monitor vitals sign of the object, including heart rate, breathing, temperature, body fat and the percentage body fat. The latter assists in determining whether an animal is A2, B3, B5, C5, etc. of an animal. A second sensor (not shown) is provided on the second ear (or elsewhere) of the animal. This sensor will periodically send out an electrical pulse which will be received by the tag 12. This information/measurement will be used along with, the animals weight, height, build (for instance type of cattle, sheep, etc.) to determine the amount of body fat and therefore the percentage body fat can be calculated and from that the class of the ‘carcass”.

1. A monitoring system, includes
(a) at least one tag adapted to be associated with an object to be monitored, the tag having at least one transmitter;
(b) at least one field station having at least one receiver, the field station is accorded a fixed location and GPS coordinates and being adapted to determine the relative position of the tag(s) relative to the field station(s) by means of radio location; and
(c) calculation means for calculating the global positioning system coordinates of the object to be monitored when provided with a tag.

2. A system as claimed in claim 1, which includes at least one base station adapted to communicate with at least one component selected from the group consisting of the field station(s) and/or the tag(s).

3. A system as claimed in claim 1, which includes triangulation mapping means to determine the global positioning system coordinates of the object to be monitored.

4. A system as claimed in claim 1, which includes pre-plotted GPS (Global Positioning System) mapping means to determine the global positioning system coordinates of the object to be monitored.

5. A system as claimed in claim 1, which is adapted to be used to determine the global position of at least one component selected from the group consisting of movable property and/or equipment at any given time from any given place.

6. A system as claimed in claim 1, which is adapted to be used to monitor and/or control property and/or equipment.

7. A system as claimed in claim 1, which is adapted to be used to continuously track and/or monitor objects.

8. A system as claimed in claim 1, in which the object is capable of moving.

9. A system as claimed in claim 1, which is adapted to be used to control equipment.

10. A system as claimed in claim 1, in which the tag is an intelligent, self-contained electronic device.

11. A system as claimed in claim 1, in which the tag is adapted to be associated and/or fixed to the object to enable monitoring of vital signs of the object.

12. A system as claimed in claim 1, which includes attaching means to attach the tag to livestock.

13. A system as claimed in claim 1, in which the tag contains a GPS module.

14. A system as claimed in claim 13, in which the tag is adapted to send position information acquired from the GPS module to a field station, adapted to relay the position to the base station.

15. A system as claimed in claim 2, in which the base station(s),field station(s) and/or tag(s) is (are) adapted to communicate by means of radio signals, relays information to and from each other and hand-held units.

16. A system as claimed in claim 1, in which the field stations have been surveyed and accorded GPS coordinates.

17. A system as claimed in claim 1, in which the calculation means is adapted to log and evaluate information received from the respective tag(s) and field station(s).

18. A system as claimed in claim 1, which is adapted to provide data to be viewed by approved user(s) globally via the Internet, SMS messaging systems and/or mobile communication devices.

19. A system as claimed in claim 1, in which the object is an animal, live stock, wild life and/or domestic animal.

20. A system as claimed in claim 3, in which the triangulation mapping means is adapted to measure out/map out an area in surveying by means of calculations based in a network of triangles measured from a base line.

21. A system as claimed in claim 1, which includes GPS mapping means adapted to establish a border and which is adapted to notify the base station if such border is breached.

22. A system as claimed in claim 1, which is adapted to provide the global position of an object at any given time from any given place and monitor some of the vital signs of the object.

23. A system as claimed in claim 1, which is adapted to be utilized for at least one of the functions selected from the group comprising
(a) an early warning system against theft;
(b) determining and/or predicting of grazing patterns;
(c) determining the fertility of the animals;
(d) tracking of animal migrations/movements;
(e) facilitating game viewing;
(f) facilitating game hunting; and
(g) determining position of an injured, sick or dead animal.

24. A system as claimed in claim 1, which is adapted to activate/deactivate remote property or equipment.

25. A system as claimed in claim 1, which is adapted to respond on remote system events of remote property or equipment.

26. A system as claimed in claim 1, which is adapted to set and/or obtain remote system properties of remote property or equipment.

27. A system as claimed in claim 1, which is adapted to execute methods on remote systems of remote property or equipment.

28. A system as claimed in claim 1, in which the tag is adapted to communicate via a radio frequency (wireless) link.

29. A system as claimed in claim 1, in which the tag is adapted to transmit and receive data.

30. A system as claimed in claim 1, in which the tag is provided with a unique identification number (UID).

31. A system as claimed in claim 1, in which the tag is unique in order to distinguish it from another tag.

32. A system as claimed in claim 1, in which the tag(s) is (are) adapted to monitor and/or control the object.

33. A system as claimed in claim 1, which is adapted to monitor vitals sign of the object.

34. A system as claimed in claim 33, in which the vital signs include at least one sign selected from the group comprising heart rate, breathing, temperature, body fat and the percentage of body fat.

35. A system as claimed in claim 1, which is adapted to provide protection against tampering of the object.

36. A system as claimed in claim 1, which is adapted to monitor any data related to the working of the object.

37. A system as claimed in claim 1, which is adapted to control any function related to the working of the object.

38. A system as claimed in claim 1, in which the tag is self-contained.

39. A system as claimed in claim 1, in which the tag is adapted to be powered by a battery.

40. A system as claimed in claim 1, in which the tag is adapted to communicate with field stations and/or with another tag.

41. A system as claimed in claim 1, in which the field station is a fixed beacon that gathers information from the individual tags via a wireless link.

42. A system as claimed in claim 1, in which the field station is a mobile hand-held unit.

43. A system as claimed in claim 1, in which the field station can be surveyed.

44. A system as claimed in claim 1, in which the field station is (in the case of a mobile unit) provided with a GPS to pin-point its location.

45. A system as claimed in claim 1, in which the field station is adapted to calculate a tags position, relative to themselves, by means of radio direction finding (RDF) and triangulation

46. A system as claimed in claim 1, in which the tag's absolute position is a function of the field station's position and the tag's relative position.

47. A system as claimed in claim 2, in which the field station(s) is (are) adapted to communicate position data of the tag(s) to the base station.

48. A system as claimed in claim 1, in which the field station is self-contained.

49. A system as claimed in claim 1, in which the field station is adapted to be powered by a battery.

50. A system as claimed in claim 1, in which the field station is tamper proof.

51. A system as claimed in any one of the preceding claims, in which the field station is provided with a unique identification number (UID).

52. A system as claimed in claim 1, in which the field station is unique to distinguished itself from another field station.

53. A system as claimed in claim 2, in which the field station is adapted to communicate (wireless link) with a base station, tags and/or with another field station.

54. A system as claimed in claim 1, in which the base station is adapted to gather the tag and field information.

55. A system as claimed in claim 54, in which the information data is recorded into a database for a user to view at any time.

56. A system as claimed in claim 54, which is adapted to allow a user to view and/or study the information by way of graphical user interface (GUI).

57. A system as claimed in claim 2, which is adapted to allow a user to view historical data as well as real time data at the base station or globally via the internet.

58. A system as claimed in claim 1, which is adapted to allow data to be relayed to a user via e-mail or SMS messages.

59. A system as claimed in claim 1, which is adapted to allow a user to query an individual tag for information.

60. A system as claimed in claim 56, in which the GUI is adapted to provide graphical feedback like heart rate over time, temperature over time and position over time.

61. A system as claimed in claim 56, in which the GUI is adapted to run on a Microsoft or Linux operation system.

62. A system as claimed claim 1, which is adapted to be operated by a system approved user(s).

63. A system as claim in claim 1, which is adapted to monitor motion of the object.

64. A system as claimed in claim 39, in which the battery is charged by solar energy.

65. A system as claimed in claim 49, in which the battery is charged by solar energy.

66. A system as claimed in claim 1, which includes a sensor adapted to send out an electrical pulse adapted to be received by the tag, and which pulse is then analyzed to determine the amount of body fat and/or percentage body fat of the object.

67. A system as claimed in claim 66, in which the sensor is located on an ear or other body part of the object.

68. A method for monitoring objects, which includes the steps of
(a) providing at least one tag associated with an object to be monitored;
(b) providing at least one field station adapted to determine the relative position of the tag(s) relative to the field station(s); and
(c) calculating the global positioning system coordinates of the object to be monitored by means of calculating means.

69. (canceled)

70. (canceled)
